(19) United States
(12) Patent Application Publication
(10) Pub. No.: US 2006/0275590 A1
(43) Pub. Date: Dec. 7, 2006

(54) Method of printing a durable UV cured ink design on a substrate

(76) Inventors: Daniel William Lorenz, Hudson, WI (US); Marc Arlen Olson, Hugo, MN (US); Katherine Joy Wilson, Eagan, MN (US)

Correspondence Address: JACOBSON & JOHNSON, ONE WEST WATER STREET, SUITE 285, ST. PAUL, MN, 55107, US

(21) Appl. No.: 11/444,928

(22) Filed: Jun. 1, 2006

Related U.S. Application Data
(60) Provisional application No. 60/687,257, filed on Jun. 3, 2005.

(51) Int. Cl. B41M 5/00

(52) U.S. Cl. 428/195.1

(57) ABSTRACT

A decorative substrate containing a durable UV-cured ink design and a method of forming a substrate containing a durable UV-cured ink design wherein the method includes the steps of treating a substrate to increase the adhesion property of a surface of the substrate, coating the treated surface of the substrate with an acrylic polyurethane mixture, allowing the acrylic polyurethane coated substrate to set, and then printing a UV-cured ink design on the substrate surface.

### CROSS REFERENCE TO RELATED APPLICATIONS

This application claims priority to currently pending U.S. Provisional Application Ser. No. 60/687,257; filed on Jun. 3, 2005; titled METHOD OF PRINTING A SUBSTRATE.

### STATEMENT REGARDING FEDERALLY SPONSORED RESEARCH OR DEVELOPMENT

None

### REFERENCE TO A MICROFICHE APPENDIX

None

### FIELD OF THE INVENTION

This invention relates generally to the printing of a substrate and, more specifically, to a process of making of a substrate containing durable printed image thereon.

### BACKGROUND OF THE INVENTION

Inkjet printers, such as flatbed inkjet printers, using UV-curable ink have become increasingly popular in the substrate printing industry because of the flexibility and production that they provide. More specifically, the aforementioned UV-curable inkjet printers allow their users to print on a wide range of substrates, are environmentally friendly as they do not emit volatile organic compounds thereby reducing the need for special ventilation and disposal system, provide enhanced weather resistance and chemical resistance, operate at high output rates, and are capable of delivering high resolution.

In general regard to the UV-printing process, the UV-curable ink used in the above-mentioned UV-curable inkjet printers generally comprise three primary components, namely, monomers, oligomers and photo-inhibitors. Monomers are organic solids and are reactive dilutant with a low molecular weight which create a homogenous solution and impart the surface characteristics of the ink. Use of the monomers in the printing process is preferred, because monomers do not release volatile organic compounds into the air as solvents do, but instead become a part of the polymer matrix of the ink film. In regards to the oligomers, oligomers form the chemical frame of the UV-curable inks and determine the final properties of the cured ink layer applied to a substrate. These properties include the ink layer's flexibility, weather resistance and chemical resistance.

Finally, the photo-inhibitors control the start and completion of the ink curing process as they absorb ultra-violet energy from a light source focused at the print surface that causes the photo-inhibitors to fragment into reactive materials. The aforementioned starts a process called polymerization, which comprises a chemical reaction that converts liquid ink into a solid, which adheres to the printed substrate.

Although UV-curable inkjet printers provide advantages compared to the prior art, one of the major problems in the use of the UV-curable inkjet printers has been ink stabilization such as adhesion of the UV-curable ink to various substrates. That is, the UV inks may not form a durable image on the surface of the substrate, which the UV inks are printed on. A durable image is defined in the present as an image, which will maintain its adhesion to the surface of the substrate and is not easily wiped off the substrate surface. Various methods such as flame plasma surface treatment have been used in the art in attempts to resolve the adhesion problem associated with using UV curable ink. Flame plasma surface treatment comprises increasing the surface energy of the substrate through the use of flame plasma in order to increase the receptability of the surfaces of some substrates to UV ink. However, one of the negatives of using flame plasma surface treatment is that it is limited only to certain durable substrates.

It has also been discovered that the use of the UV-curable ink for printing on various types of substrates may require specific combinations of the ink, the anchor coating, and the overcoat in order to obtain the optimized or desired result generally for each type of substrate. The aforementioned can be undesirable for users who wish to print UV curable ink on different types of substrates, as the user will have to invest time and money in order to procure the appropriate combination of ink, anchor coating, and/or overcoat for each type of substrate in order to obtain the optimized or desired result.

### BRIEF SUMMARY OF THE INVENTION

The present invention provides for a substrate containing a durable printed image thereon and a method of printing that durable printed image on the substrate using UV-curable ink. The method comprises the steps of treating a substrate to increase the adhesion property of the surface of the substrate followed by coating the treated surface with an acrylic polyurethane mixture comprising paint, a catalyst, and a reducer. Once coated, the substrate is allowed to set, after which a UV ink design is printed on the substrate surface using a UV-curable inkjet printer. As the UV-curable inkjet printer prints the UV ink design on the substrate surface, the UV curable ink printed on the substrate surface is exposed to a UV light source, which changes the UV curable ink from a liquid state to a solid state. Once the UV-curable inkjet printer finishes printing the UV ink design on the substrate surface, the UV ink printed design on the substrate surface is allowed to cure to obtain the properties of a cured system. The aforementioned method can also include the step of baking the substrate having the UV-cured ink design thereon to increase curing rate of the UV-cured ink design.

### DESCRIPTION OF THE PRIOR ART

U.S. Pat. No. 6,312,123 teaches a method of ink jet printing onto fabrics with ultra-violet light (UV) curable inks.

U.S. Pat. No. 6,648,470 teaches an indirect digital printing system in which an ink image is formed on a printing member for subsequent transfer onto a printing substrate.

U.S. Pat. No. 6,726,317 teaches a method and apparatus for ink jet printing a digital image onto textiles and curing the image printed on the textile with UV or other energy, a chemical curing agent or other curing medium.

U.S. Pat. No. 6,754,551 teaches an apparatus and method for depositing various patterns on printed circuit boards using jet-dispensing technology.

U.S. Pat. No. 6,899,775 teaches the printing of a substrate having a pre-printed print pattern with a design layer of ink with differential adhesion within and without the print pattern.

### BRIEF DESCRIPTION OF THE DRAWINGS

FIG. 1 shows a flowchart of a method for forming a substrate containing durable printed image thereon; and

FIG. 2 shows a flowchart of an alternative method for forming a substrate containing durable printed image thereon.

### DESCRIPTION OF THE PREFERRED EMBODIMENT

As used hereinafter, a “substrate” can comprise any type of material that can be coated with an acrylic polyurethane coating or the like and can include a single sheet of homogenous material or a multi-layered material or assembly. Examples of possible substances for forming the substrate include but are not limited to various types of metals including magnesium, zinc, aluminum, and combinations thereof; various types of plastics including polyethylene, acrylic plastics, polycarbonate, various photopolymers; ceramics; and wood. The aforementioned substrates may comprise various thicknesses and also may vary in surface contours and background color(s).

In regards to the UV inkjet printer used in the present invention, it is noted that UV inkjet printing hardware is commercially available from a number of companies including Minnesota Mining, and Manufacturing Company (3M) of Saint Paul, Minn. and Mimaki Engineering Co., Ltd of Tokyo, Japan. It is noted that although other types of UV inkjet printing hardware can be used, the Mimaki UV curable Inkjet Printer, Model Number UJF-605C was used with the present invention due to the aforementioned printer's high precision and high-resolution capabilities, namely with resolutions of up to 1,200 dpi (dots per inch) by 2,400 dpi (dots per inch) or even higher.

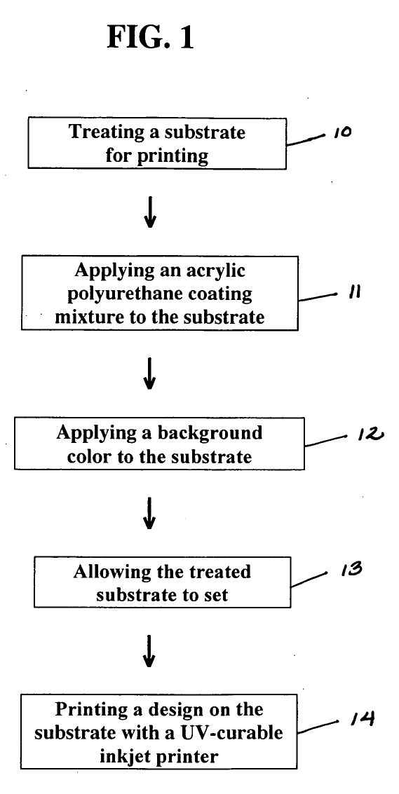

As shown in FIG. 1, the process of printing a durable design on the substrate starts with the preparation or treating of the substrate for printing 10 by cleaning the substrate, priming the substrate, and/or treating the substrate with a chemical or exposing the substrate to a heat source or both in order to increase the receptability of the substrate surface to the process of adhesion. An example of the aforementioned would be to apply a sealer to a wood substrate to increase the adhesion of the surface of the wood substrate. For magnesium and zinc substrates, a mild caustic solution may be used to clean the substrate surface and strip any resist that is present on the substrate surface. The magnesium and zinc substrates are then primed using a zinc chromate primer.

In regards to the above treating of the substrate for printing 10, it is noted that although the above step 10 is preferred and sometimes required for certain substrates, the step of treating the substrate for printing 10 may be optional for substrates that already have surfaces with satisfactory receptability to the process of adhesion.

After the substrate has been prepared for printing, an acrylic polyurethane coating mixture is then applied to the substrate 11. Although an acrylic polyurethane coating mixture comprising paint, a catalyst, and a reducer is currently being used, it is noted that other types of acrylic polyurethane coating mixture can also be used in the present invention to coat the substrate. An example of an acrylic polyurethane coating mixture used in acrylic polyurethane coating step 11 comprises a mixture composition of 3 parts paint, 1 part catalyst, and 1 part reducer.

In regards to the application of the acrylic polyurethane coating mixture to the substrate 11, it is also noted that the acrylic polyurethane coating mixture can be applied to the substrate through a variety of methods including but not limited to dipping the substrate into the acrylic polyurethane coating mixture or spraying the acrylic polyurethane coating mixture onto the substrate.

Once the acrylic polyurethane coating mixture is applied to the substrate 11, a background color is then applied to the substrate 12. The background color can be acrylic polyurethane (i.e. clear or translucent) or a white ultra violet (UV). In further regards to the color of the background, it is noted that although a white color background is usually applied to the substrate as standard UV-cured inks generally provide a predictable desired color characteristics and intensity when they are printed directly onto white color background, other types of colored backgrounds can be used to obtain different design effect. Similar to the acrylic polyurethane coating mixture, the background color can be applied to the substrate through a variety of methods including but not limited to dipping the substrate into the paint or spraying the background color onto the substrate.

Referring back to FIG. 1, after the background color is applied to the substrate 12, the treated substrate is allowed to set for a specific period of time 13. The aforementioned setting time of the treated substrate generally comprises less than an hour but is dependent on the temperature at which the treated substrate is allowed to set (which typically is at room temperature), and the type of substrate material.

Once the treated substrate has set to an acceptable level, the substrate is then placed in the flat bed UV Inkjet Printer after which a predetermined design is printed thereon by the UV Inkjet Printer 14. In regards to the general operation of the above UV inkjet printer, a substrate is first placed on the printing bed of the UV inkjet printer after which the UV inkjet printer receives information from the computer to determine the precise position of the substrate on the printing bed. The aforementioned can be achieved for example through a substrate registration process. An electronic image to be printed onto the substrate is entered into a computer linked to and controlling the UV inkjet printer.

Once the image is entered, the computer then sends information to the UV inkjet printer to initiate the printing process. During the printing process, a printer head of the UV inkjet printer moves along the substrate leaving droplets of the UV-light curable ink on demand. As the droplets of UV-curable ink are applied to the substrate, an Ultraviolet light source located proximal the printer head of the UV inkjet printer exposes the UV-curable ink to Ultraviolet light rays to polymerize or adhere the UV-curable ink to the substrate. That is, exposure of the UV-curable ink to the UV light rays causes the printed portion of the UV-curable ink to change from a liquid state to a solid state. The printed design thus dries instantly and can be handled, stacked, or cut without problems generally associated with traditional solvent-based inks such as smudging of the ink.

It is noted that it has been discovered that an advantage of the present invention is that unlike some prior art which require the presence of a pre-printed print pattern with a design layer where there is a differential adhesion within and without the printed pattern, an advantage of the present invention is that a digital image of UV curable ink can be printed on a substrate surface that has uniform UV curable ink adhesion or receptability properties throughout the substrate surface. The aforementioned allows for increased productivity through the elimination of a pre-printed print pattern process where there is a differential adhesion within and without the printed pattern.

Although the printed design printed on the receiving surface of the substrate can comprise a single color printed over a different colored background, the printed design of the present invention preferably comprises a multi-color printing process with the base colors typically comprising the colors black, cyan, magenta, and yellow.

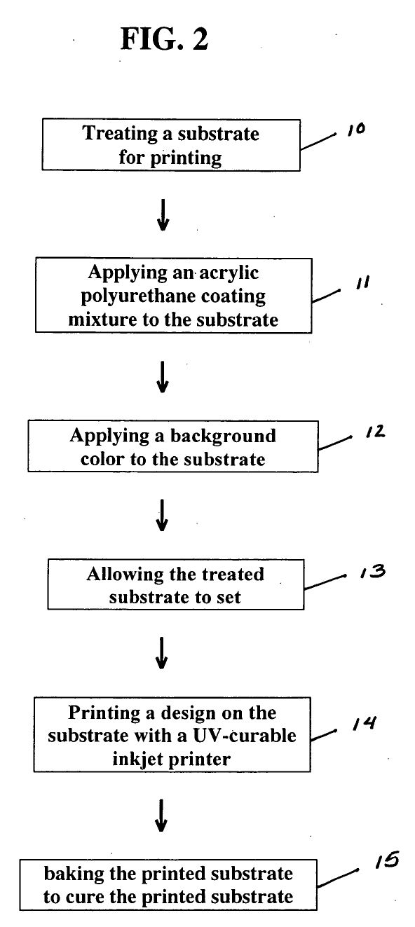

Referring to FIG. 2, FIG. 2 also shows a flowchart of a standard method of printing a durable image on a substrate surface using a UV inkjet printer. As shown in FIG. 2, the steps of the method of FIG. 2 are similar to the steps of FIG. 1 in that the steps of the method of FIG. 2 include steps 10, 11, 12, 13, and 14 of FIG. 1. However, the method of FIG. 2 further includes the step of baking the substrate containing the UV ink printed design 15 thereon in order to increase the curing rate of the substrate. It is noted that the term baking can be defined as exposing the substrate to a heat source such as but not limited to an oven, a heat lamp, or the sun.

It is noted that the aforementioned step, namely, baking the substrate containing the UV ink printed design thereon 15 is not performed on all substrates as not all substrates can be exposed to heat. For substrates that can be exposed to the baking process, the substrates are baked for an appropriate time at an appropriate temperature in order to speed up the curing time of the substrate. The appropriate time and the appropriate temperature that each substrate is exposed to the heat source to cure the substrate are dependent on substrate material and thickness. In regard to temperature range, it is noted that the cured ink on the printed design has an upper temperature threshold to which the cured ink can be exposed without burning out. It has been found that the temperature range for baking the cured ink of the printed design in order to obtain improved results, namely increasing the curing rate while maintaining the properties of the cured system, may range from 120° F. to 400° F. It is noted that the aforementioned temperature range is the temperature at which the substrate is baked.

It is noted that the aforementioned temperature range of 120° F. to 400° F. is the temperature range to which the cured ink on the printed design is exposed during the baking process. It has been found that on substrates containing the UV ink printed design that are exposed to temperatures less than 120° F, the curing period is not noticeably different from substrates containing the UV ink printed design that are cured at room temperature. It has also been found that for substrates containing the UV ink printed design that are exposed to temperatures greater than 300° F, the UV ink begins to break down or burn out with the level of breakdown or burn out increasing as the temperature increases above 300° F.

It is noted that oven heating temperatures and oven time may be varied, depending on a number of conditions including the nature of the substrate, the density of the substrate, the thickness of the substrate, the type and composition of the UV curable ink, etc . . . .

In a test to determine the effective baking temperature for exposing the substrates, three types of substrates, namely , a zinc substrate, a magnesium substrate, and a polymer substrate having a thickness of 0.153 inches for the zinc substrate, 0.153 inches for the magnesium substrate, and 0.160 inches for the polymer substrate were exposed to temperatures at 180 degrees Fahrenheit; to temperatures at 210 degrees Fahrenheit; to temperatures at 240 degrees Fahrenheit; to temperatures at 270 degrees Fahrenheit; and to temperatures at 300 degrees Fahrenheit during a baking process for 21 minutes. The samples of substrates were then allowed to cool for 24 hours after which each was subjected to a rub test. The rub test comprised soaking a rough-surfaced rag with an aggressive solvent and rubbing the cured ink design on each of the sample substrates hard 30 times. Results of the rub test revealed that all of the zinc, magnesium, and polymer substrate samples that were baked at 180 degrees Fahrenheit caused some coloration of the rag but it was ever so slight and did not change the appearance of the sample other than adding a shine to the area that had been rubbed.

Once cured through the baking process, the painted substrate will obtain the properties of the cured system, namely enhanced weather resistance and chemical resistance. It is noted that one of the advantages of the present invention is that the designs and images printed with the UV-curable ink printer can provide durability for up to several years. In addition, the images printed on the substrate can be cleaned using strong solvents and cleaners to remove dirt and possibly even graffiti to provide longer useful life without damage to the image.

For substrates that are not baked or cannot be baked, the curing period, which comprises allowing the UV ink printed design on the substrate surface to cure at room temperature, and can typically take up to 7 days in order to obtain the properties of the cured system, again namely enhanced weather resistance and chemical resistance.

It is noted that after the above substrates have cured, the cured substrate can be further coated or sanded, such as sanding out various metal areas of a metal substrate in order to obtain special/artistic effects with little or no damage to the image.

I claim:

1. A method of printing a durable image on a substrate comprising the steps of:
coating said treated surface with an acrylic polyurethane mixture;
allowing said acrylic polyurethane coated substrate to set; and then
printing a UV-cured ink design on said substrate surface.

2. The method of claim 1 including the step of treating a substrate to increase the adhesion property of surface of said substrate.

3. The method of claim 1 including the step of applying a background color to said substrate surface to provide a desired color characteristics and intensity.

4. The method of claim 1 wherein the step of printing said UV-cured ink design on said substrate surface comprises printing said UV-cured ink design on said substrate surface using a UV-curable inkjet printer.

5. The method of claim 1 wherein said UV-cured ink design is digitally printed on said substrate by a UV curable inkjet printer.

6. The method of claim 1 wherein the step of treating the substrate to increase the adhesion property of a surface of said substrate comprises cleaning said substrate surface, priming said substrate surface and treating said substrate surface with a chemical to increase the adhesion property of a surface of said substrate.

7. The method of claim 1 wherein the step of treating the substrate to increase the adhesion property of a surface of said substrate comprises cleaning said substrate surface, priming said substrate surface and exposing said substrate surface to a heat source to increase the adhesion property of a surface of said substrate.

8. The method of claim 1 wherein the acrylic polyurethane coating mixture comprises paint, a catalyst, and a reducer.

9. The method of claim 1 including the step of exposing said substrate having said UV-cured ink design thereon to a heat source to increase curing rate of said substrate.

10. The method of claim 9 wherein said substrate having said UV-cured ink design thereon is exposed to a temperature between 120° F. and 400° F. to increase curing rate of said substrate.

11. The method of claim 9 wherein said substrate having said UV-cured ink design thereon is exposed to a temperature between 180° F. and 300° F. to increase curing rate of said substrate.

12. A method of forming a substrate containing a durable UV-cured ink design comprising the steps of:
treating a substrate to increase the adhesion property of a surface of said substrate;
coating said treated surface with an acrylic polyurethane mixture;
allowing said acrylic polyurethane coated substrate to set;
printing a UV ink design on said substrate surface using a UV-curable inkjet printer;
exposing the UV curable ink printed on said substrate surface to a UV light source to change said UV curable ink from a liquid state to a solid state; and then
allowing said UV ink printed design on said substrate surface to cure to obtain the properties of a cured system.

13. The method of claim 12 including the step of applying a background color to said substrate surface to provide a desired color characteristics and intensity.

14. The method of claim 12 wherein the step of allowing said UV ink printed design on said substrate surface to cure comprises allowing said UV ink printed design on said substrate surface to cure at room temperature.

15. The method of claim 12 wherein the step of allowing said UV ink printed design on said substrate surface to cure comprises exposing said substrate having said UV-cured ink design thereon to a heat source to increase curing rate of said substrate.

16. The method of claim 12 wherein the step of allowing said UV ink printed design on said substrate surface to cure comprises exposing said substrate having said UV-cured ink design thereon to a temperature between 120° F. and 400° F. to increase curing rate of said substrate.

17. A decorative substrate containing a durable UV cured ink design comprising:
a substrate;
an acrylic polyurethane coating mixture comprising a paint, a catalyst, and a reducer; and
a UV-cured ink design.

18. The decorative substrate of claim 17 wherein the substrate is composed of metal, plastics, ceramics, or wood.

19. The decorative substrate of claim 17 wherein the acrylic polyurethane coating mixture comprises a paint, a catalyst, and a reducer.
